(19) United States
(12) Patent Application Publication
(10) Pub. No.: US 2009/0092741 A1
(43) Pub. Date: Apr. 9, 2009

(54) METHOD FOR FORMING FILM AND FILM FORMING SYSTEM

(76) Inventors: Kozo Ishida, Kyoto (JP); Koji Tominaga, Kyoto (JP); Koichiro Matsuda, Kyoto (JP); Tetsuo Shimizu, Kyoto (JP); Jiro Senda, Kyoto (JP); Motohiro Oshima, Kyoto (JP); Akiko Komeda, Kyoto (JP)

Correspondence Address: SNELL & WILMER LLP (OC), 600 ANTON BOULEVARD, SUITE 1400, COSTA MESA, CA, 92626, US

(21) Appl. No.: 11/908,650

(22) PCT Filed: Mar. 13, 2006
(86) PCT No.: PCT/JP2006/304904

§ 371 Date: Oct. 20, 2008

(30) Foreign Application Priority Data
Mar. 18, 2005 (JP) 2005-078810

(51) Int. Cl. B05D 1/02; B05C 5/00

(52) U.S. Cl. 427/8; 427/248.1; 118/710

(57) ABSTRACT

The present claimed invention is a film forming system 1 that forms a film by vaporizing a liquid precursor and then depositing the vaporized liquid precursor on a substrate 2, and comprises a chamber 3 inside of which the substrate 2 is held, an injection valve 4 that directly injects the liquid precursor into the chamber 3, and a control unit 11 that alternately sets a supplying period while the liquid precursor is directly injected into the chamber 3 to supply the liquid precursor in a vaporized state and a supply halt period while the liquid precursor is not supplied into the chamber 3 and controls the supplying period and the supply halt period by periodically opening and closing the injection valve 4 so as to intermittently supply the liquid precursor into the chamber 3, and is characterized by that the control unit 11 controls the supply halt period to be equal to or longer than a migration/evaporation period necessary for atoms or molecules of the liquid precursor deposited on the substrate 2 to migrate and necessary for a reaction by-product material generated on the substrate 2 to evaporate. An object of this invention is to generate a thin film of high grade having less impure substances.

### FIELD OF THE ART

This invention relates to a method for forming a film and a film forming system, more specifically to a method for forming a film and a film forming system by the use of a chemical vapor deposition method (CVD method).

### BACKGROUND ART

Conventionally, a film forming system by the use of the CVD (Chemical Vapor Deposition) method continuously supplies a liquid precursor as being a starting material into a chamber and forms a thin film by initiating thermal decomposition or an oxidation reaction on a target substrate as being an object to be processed in the chamber.

However, if the liquid precursor is continuously supplied into the chamber, there is a problem that atoms or molecules of the liquid precursor deposited on the substrate can not fully migrate during a process of the CVD method, resulting in failing to form a refined thin film.

In addition, if the liquid precursor is continuously supplied, a film is formed in a state that a reaction by-product material on the substrate does not fully evaporate and the reaction by-product material remains in the thin film as an impure substance, resulting in limitations for forming a thin film of high grade.

Meanwhile, as shown in non patent document 1, there is a method for forming a thin film by injecting the liquid precursor intermittently into the chamber with switching multiple injecting valves by the use of a digital CVD method.

With this method, however, since the liquid precursor that is not supplied is discarded while the liquid precursor is supplied alternately, a large amount of unused liquid precursor has to be discarded in case of forming a thin film, thereby increasing a cost of the liquid precursor.

In addition, in case of forming a thin film with a film forming system by the use of the CVD method, as shown in the patent document 1, a thickness of the deposited film is continuously monitored by the use of an ellipsometer, a Fourier transform infrared spectrophotometer (FTIR) or the like.

However, in case that the liquid precursor is continuously supplied into the chamber, since the thickness of the deposited film changes because the film forming is proceeding while the thickness of the deposited film is measured by the ellipsometer or the FTIR, it becomes difficult to control a process of forming a film based on the measured thickness of the deposited film.

Non patent document 1: Jpn, J: Appl. Phys. Vol. 32 (1993) pp. 4078-4081 [Preparation of Tetragonal Perovskite Single Phase PbTiO3 Film Using an Improved Metal-Organic Chemical Vapor Deposition Method Alternately Introducing Pb and Ti Precursors]
Patent document 1: Japan patent laid-open number 2001-332534

### DISCLOSURE OF THE INVENTION

### Problems to be Solved by the Invention

The present claimed invention intends to solve all of the problems and a main object of this invention is to form a thin film of precise and high grade having less impure substances and to effectively utilize a liquid precursor. Furthermore, this invention makes it possible to form a thin film of high grade by accurately controlling a film forming process of the CVD method.

### Means to Solve the Problems

More specifically, a film forming method in accordance with this invention is a film forming method for forming a film by directly injecting a liquid precursor through an injecting valve into a chamber inside of which a substrate is held, vaporizing the liquid precursor and then depositing the vaporized liquid precursor on the substrate, and comprises a period setting step to set a migration/evaporation period necessary for atoms or molecules of the liquid precursor on the substrate to migrate and necessary for a reaction by-product material generated on the substrate to evaporate, and an intermittent supplying step that is alternately provided with a supplying period while the liquid precursor is supplied by directly injecting the liquid precursor into the chamber and vaporizing the liquid precursor and a supply halt period while the liquid precursor is not supplied into the chamber, and is characterized by that the supply halt period is set to be equal to or longer than the migration/evaporation period in the intermittent supplying step.

In accordance with this method, since migration of the atoms or the molecules in the deposited thin film and vaporization of the reaction by-product material can be fully conducted, it is possible to produce a thin film of high grade having less impure substances. Furthermore, the liquid precursor can be effectively made use of.

In order to fully conduct migration of the atoms or the molecules and to further promote evaporation of the by-product material, it is preferable that the liquid precursor is supplied into the chamber by opening/closing the injection valve multiple times at predetermined intervals during the supplying period of the intermittent supplying step.

Furthermore, in order to further distinguish the effect of this invention and to form a thin film of high grade, it is preferable that the supply halt period is longer than the supplying period while the liquid precursor is supplied into the chamber. The supplying period is determined based on an area of an object to be film-formed of the substrate, a pressure, temperature, or a volume of the chamber or the liquid precursor.

As a concrete embodiment of the supplying period and the supply halt period, it can be conceived that the supply halt period is longer than or equal to about fifty times of the supplying period.

In order to embody this method for forming a film, it is possible to use, for example, a film forming system that forms a film by vaporizing a liquid precursor and then depositing the vaporized liquid precursor on a substrate and that comprises a chamber inside of which the substrate is held, an injection valve that directly injects the liquid precursor into the chamber, and a control unit that alternately sets a supplying period while the liquid precursor is directly injected into the chamber to supply the liquid precursor in a vaporized state and a supply halt period while the liquid precursor is not supplied into the chamber and controls the supplying period and the supply halt period by periodically opening and closing the injection valve so as to intermittently supply the liquid precursor into the chamber, and that is characterized by that the control unit controls the supply halt period to be equal to or longer than a migration/evaporation period necessary for atoms or molecules of the liquid precursor on the substrate to migrate and necessary for a reaction by-product material generated on the substrate to evaporate. This film forming system also is one embodiment of this invention.

In accordance with this arrangement, since migration of the atoms or the molecules in the deposited thin film and vaporization of the reaction by-product material can be fully conducted, it is possible to produce a thin film of high grade having less impure substances. Furthermore, the liquid precursor can be effectively made use of.

In order to allow the atoms or the molecules to fully migrate and to further promote evaporation of the reaction by-product material, it is preferable that the control unit opens and closes the injection valve multiple times at predetermined intervals during the supplying period so as to supply the liquid precursor into the chamber.

As an embodiment to accurately control a flow rate of the injected liquid precursor, it is preferable that the injection valve is electromagnetic which comprises an electromagnetic coil and a valve plug that opens and closes an injection tip by means of electromagnetic induction of the electromagnetic coil.

In addition, in order to restrain generation of oxygen deficit in a metal oxide film or nitrogen deficit in a metal nitride film, it is preferable that the liquid precursor is a mixed solution composed of a metal compound and a low boiling point organic compound.

Furthermore, another method for forming a film in accordance with this invention is a film forming method for forming a film by directly injecting a liquid precursor through an injection valve into a chamber inside of which a substrate is held, vaporizing the liquid precursor and then depositing the vaporized liquid precursor on the substrate, and is characterized by alternately having a supplying process that supplies the liquid precursor by directly injecting the liquid precursor into the chamber and vaporizing the liquid precursor and a supply halt process that does not supply the liquid precursor into the chamber, wherein the film deposited on the substrate is optically measured in the supply halt process and the supplying process and/or the supply halt process is controlled based on the measurement result.

In accordance with this method, since migration of the atoms or the molecules in the deposited thin film and vaporization of the reaction by-product material can be fully conducted and the thickness of the film can be controlled accurately, it is possible to produce a thin film of high grade having less impure substances.

As a method for optically measuring the thin film, an ellipsometry method with high measurement accuracy is preferable.

The film forming method in accordance with this invention may also be applied to manufacture a thick film, however, this method is suitable for forming a thin film of high grade that requires strict control for a film thickness and can be preferably used for manufacturing a film whose thickness is equal to or less than, for example, 2 nm.

In order to embody this method for forming a film, it is possible to use, for example, a film forming system that forms a film by vaporizing a liquid precursor and depositing the vaporized liquid precursor on a substrate and that comprises a chamber inside of which the substrate is held, an injection valve that directly injects the liquid precursor into the chamber, a measuring device that optically measures the film deposited on the substrate, and a control unit that alternately sets a supplying process while the liquid precursor is directly injected into the chamber to supply the liquid precursor in a vaporized state and a supply halt process while the liquid precursor is not supplied into the chamber and controls the supplying process and the supply halt process by periodically opening and closing the injection valve so as to intermittently supply the liquid precursor into the chamber and that controls the measuring device to conduct the measurement during the supply halt process and controls the supplying process and/or the supply halt process based on the measurement result. This film forming system also is one embodiment of this invention.

As the measuring device, an ellipsometer or FTIR may be used, however, the ellipsometer that can measure a film thickness with high accuracy is preferable.

In order to make it possible for the film forming system in accordance with this invention to control a film thickness with high accuracy, it is preferable that the control unit comprises a film forming/measurement condition setting part that stores film forming condition information and measurement condition information, a measurement controlling part that outputs measurement controlling information for controlling each part of the measuring device based on the measurement condition information, a measurement result calculating part that calculates and outputs a measurement result of the film deposited on the substrate based on the measurement condition information and a detecting signal output by the measuring device, a judging part that judges whether or not the deposited film satisfies a predetermined film forming condition by making a comparison between the film forming condition information and the measurement result of the deposited film and that outputs judged result information, and a film forming controlling part that outputs supply process controlling information and/or supply halt process controlling information based on the film forming condition information and/or the judged result information output by the judging part so as to control each part of the film forming system.

The measurement result measured by the measurement result calculating part includes a film thickness, an optical constant such as a refraction index, and a substance characteristic, and the supply process controlling information and the supply halt process controlling information output by the film forming controlling part includes the pressure, the temperature of the chamber, the liquid precursor and the injected amount of the liquid precursor in addition to the supplying period, the supply halt period, the supplying cycle by the use of opening/closing the injection valve.

### EFFECT OF THIS INVENTION

In accordance with this invention, since migration of the atoms or the molecules in the deposited thin film and vaporization of the reaction by-product material can be fully conducted, it is possible to produce a thin film of high grade having less impure substances. Furthermore, the liquid precursor can be effectively made use of.

In addition, in accordance with this invention, a film thickness can be accurately controlled.

### BRIEF DESCRIPTION OF THE DRAWINGS

FIG. 1 is a general configuration diagram of a film forming system in accordance with a first embodiment of the present claimed invention.

FIG. 2 is a cross-sectional view of an injection valve in accordance with the embodiment.

FIG. 3 is a view showing a method for controlling the injection valve in accordance with the embodiment.

FIG. 4 is a flow chart showing an operation of the film forming system in accordance with the embodiment.

FIG. 5 is a view showing a method for controlling an injection valve of the film forming system in accordance with a second embodiment of this invention.

FIG. 6 is a general configuration diagram of a film forming system in accordance with a third embodiment of the present claimed invention.

FIG. 7 is a functional block diagram of a control unit in accordance with the embodiment.

FIG. 8 is a view showing a method for controlling an injection valve in accordance with the embodiment.

FIG. 9 is a flow chart showing an operation of the film forming system in accordance with the embodiment.

FIG. 10 is a view showing a method for controlling an injection valve of a film forming system in accordance with a forth embodiment of this invention.

### BEST MODES OF EMBODYING THE INVENTION

### First Embodiment

A first embodiment of this invention will be explained with reference to the accompanying drawings.

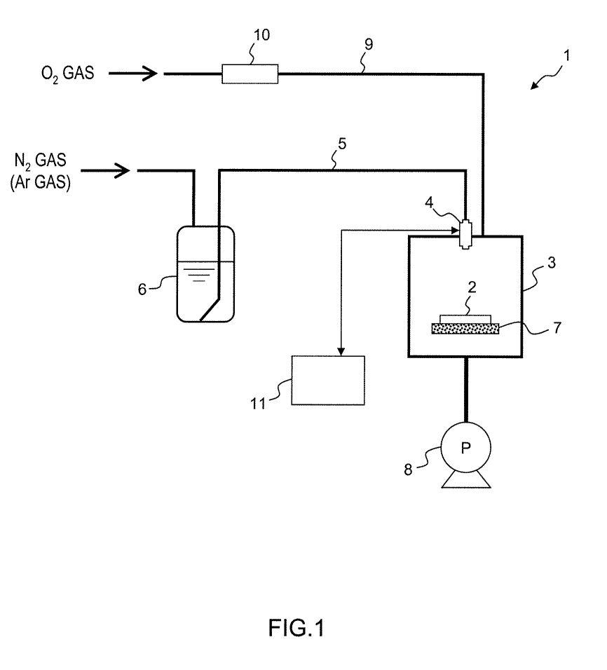

A film forming system 1 in accordance with this embodiment is, as shown in FIG. 1, a film forming system to form a film of silicon dioxide (SiO₂) on a substrate 2 as being an object to be processed by vaporizing a liquid precursor and depositing a thin film on the substrate 2. More concretely, the film forming system 1 comprises a chamber 3 inside of which the substrate 2 is held, an injection valve 4 that directly injects the liquid precursor into the chamber 3, a material supplying pipe 5 that supplies the injection valve 4 with the liquid precursor and a control unit 11 to be described later.

In this embodiment, the liquid precursor uses a mixed solution (TEOS/(TEOS+n-c₅H₁₂)=0.5 (mol ratio)) mixing, for example, Tetraethoxysilane (TEOS: (Si(OC₂H₅)₄) as being a metal compound (an organic metal compound) and, for example, n-pentane (n-C₅H₁₂) as being a low boiling point organic compound (solvent) with a mole fraction of 0.5 (mol ratio). The liquid precursor as being the mixed solution composed of Tetraethoxysilane (Si(OC₂H₅)₄) and n-pentane (n-C₅H₁₂) is stored in a container 6 made of, for example, stainless steel. The liquid precursor passes the material supplying pipe 5 due to pressurized N₂ gas pressed into the container 6 and the liquid precursor is pressure-fed to the injection valve 4 and then supplied into the chamber 3 through the injection valve (injector) 4. Furthermore, the liquid precursor is vaporized and filled into the chamber 3 because the decompression (flash) boiling spray vaporization phenomenon occurs at the same time when the liquid precursor is injected from the injection valve 4 into the chamber 3.

The chamber 3 internally holds the substrate 2 as being the object to be processed by means of a holding mechanism and has a substrate heater 7 to heat the substrate 2. The chamber 3 is depressurized by a vacuum pump 8. In addition, an oxygen supplying pipe 9 to supply oxygen (O₂) gas for fully oxidizing the film of silicon dioxide (SiO₂) also is arranged. A supply flow rate of oxygen (O₂) gas in the oxygen supplying pipe 9 is controlled by a mass flow controller (MFC) 10. Since the holding mechanism is a commonly used mechanism, a detailed explanation and a drawing are omitted.

Furthermore, a pressure in the chamber 3 is made to be both larger than a vapor pressure of Tetraethoxysilane (Si(OC₂H₅)₄) prior to being mixed with n-pentane (n-C₅H₁₂) and smaller than a vapor pressure of the mixed solution after being mixed with n-pentane (n-C₅H₁₂).

With this arrangement, since the film can be formed in a state that the pressure in the chamber 3 is kept in a lower degree of vacuum than a pressure of a conventional method, it is possible to restrain generation of oxygen deficit in a metal oxide film or nitrogen deficit in a metal nitride film, thereby to obtain the metal oxide film or the metal nitride film of high quality.

The injection valve 4 directly injects the mixed solution as being the liquid precursor into the chamber 3 and is arranged on top of the chamber 3 so as to face a surface to be film-formed of the substrate 2. The injection valve 4 is controlled to open or close by a control unit 11.

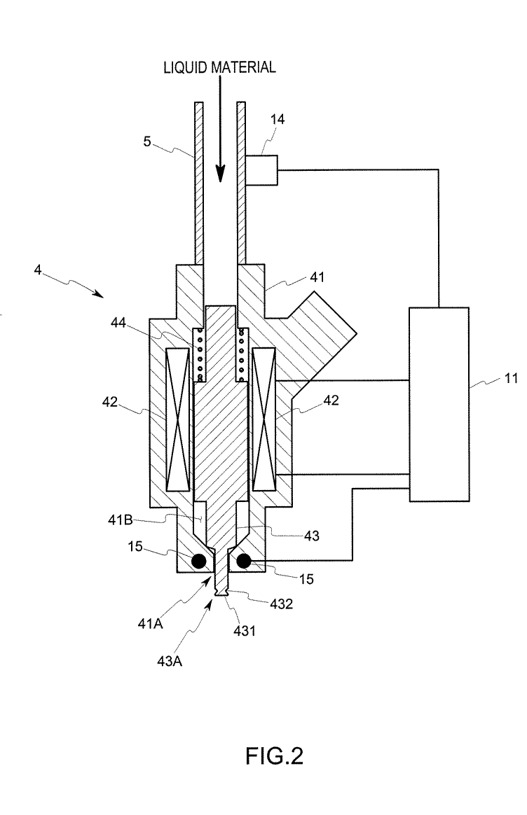

More concretely, the injection valve 4 comprises, as shown in FIG. 2, a body part 41, a solenoid 42 built-in the body part 41 and a valve plug (valve body) 43 that opens and closes the injection tip 41A by means of electromagnetic induction of the solenoid 42, and is controlled by the control unit 11. And vicinity of the injection tip 41A of the body part 41 is heated at, for example, about several dozen degrees centigrade (some degrees higher than the room temperature). FIG. 2 shows a state that the injection tip 41A is closed.

The valve plug 43 locates in an internal space 41B of the body part 41 and is urged toward a side of the injection tip 41A by a spring 44 so as to block up the injection tip 41A and an umbrella-shaped flange 431 and an annular groove 432 are formed at a distal end portion 43A of the valve plug 43.

Since a solenoid valve is used as the injection valve 4, a flow rate (a supplying amount) of the injected liquid precursor can be controlled accurately in a quick response.

The control unit 11 closes and opens the injection valve 4 periodically so as to intermittently supply the liquid precursor into the chamber 3 and controls the injection tip 41A to open by driving the solenoid 42 during the supplying period, to be described later, for injecting a predetermined amount of the liquid precursor intermittently with monitoring the pressure of the liquid precursor in the material supplying pipe 9 by the use of a pressure gauge 14.

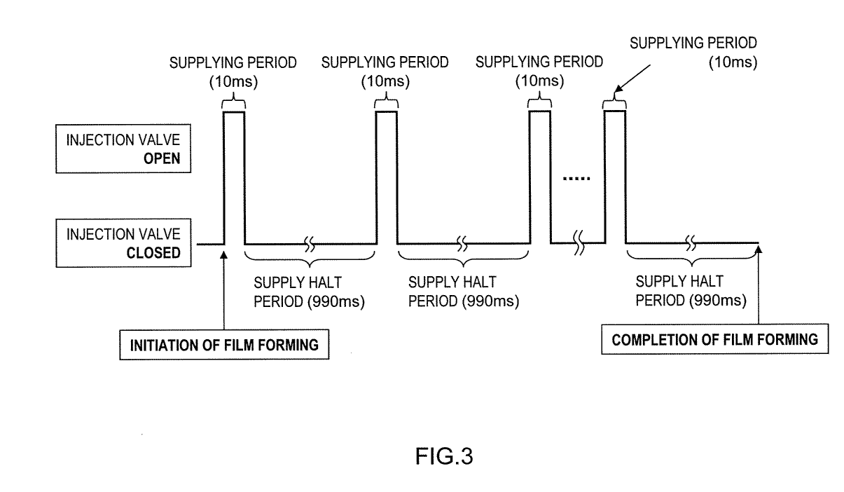

A concrete method for controlling the injection valve 4 is, as shown in FIG. 3, to control the injection valve 4 so as to periodically, more specifically, alternately repeat the supplying period as being a period while the liquid precursor is directly injected, vaporized and supplied into the chamber 3 and the supply halt period as being a period while the liquid precursor is not supplied into the chamber 3. In addition, the supply halt period is set to be more than or equal to about 50 times of the supplying period. In this embodiment, the supplying period is 10 [ms] and the supply halt period is 990 [ms].

The supplying period is set based on, for example, an area of the object to be film-formed of the substrate 2, a pressure, a temperature or a volume of the chamber 3 or the liquid precursor.

The supply halt period is set to be equal to or longer than a migration/evaporation period that is a period necessary for atoms or molecules of the liquid precursor supplied into the chamber 3 during the supplying period and deposited on the substrate 2 to migrate and necessary for a reaction by-product material generated on the substrate 2 to evaporate.

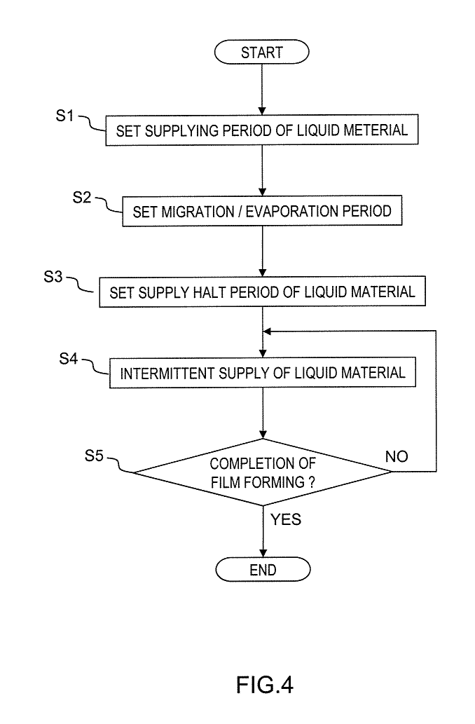

An operation of the film forming system 1 having the above-mentioned arrangement will be explained with reference to FIG. 4.

First, set the supplying period based on, for example, the area of the object to be film-formed of the substrate 2, the pressure, the temperature or the volume of the chamber 3 or the liquid precursor (Step S1).

Next, set the migration/evaporation period necessary for atoms or molecules of the liquid precursor supplied to the chamber 3 and deposited on the substrate 2 during the supplying period to migrate and necessary for the reaction by-product material generated on the substrate 2 to evaporate (Step S2).

Then, set a period that is equal to or longer than the migration/evaporation period as the supply halt period (Step S3).

Input the supplying period and the supply halt period into the control unit 11 and supply the liquid precursor into the chamber 3 intermittently by controlling the solenoid 42 based on the supplying period and the supply halt period (Step 4). Terminate an operation of the film forming system 1 if film forming is completed, or continue an operation of film forming if film forming is not completed (Step S5).

In this embodiment, the temperature of the substrate 2 is set at 650 degrees centigrade ˜700 degrees centigrade, and the pressure in the chamber 3 is set to 2 Torr. In addition, the flow rate of the oxygen (O₂) gas is set to 100 ml/min by the mass flow controller (MFC) 10.

The injection valve 4 was repeated to open/close at 500 times with a cycle of 1 Hz with the supplying period of about 10 [ms] and the supply halt period of 990 [ms].

Under this condition, a film thickness of a silicon dioxide (SiO₂) film generated on the substrate 2 was about 50 nm. Furthermore, a specific gravity (density) of the silicon dioxide (SiO₂) film was 2.17. This proved that the specific gravity of the silicon dioxide (SiO₂) film was very much close to a specific gravity (density) of quartz glass, and the silicon dioxide (SiO₂) film formed by the film forming system 1 in accordance with this embodiment was a film of pretty high density.

In accordance with thus arranged film forming system 1, since migration of the atoms or the molecules in the deposited thin film and vaporization of the reaction by-product material can be fully conducted, it is possible to produce a thin film of high grade having less impure substances. Furthermore, the liquid precursor can be effectively made use of. In addition, since there is no need of using multiple injection valves, a cost of the system can be reduced.

In addition, in case of depositing a crystalline film, it is possible to form a crystalline thin film of high quality having less lattice imperfection. Furthermore, since it is possible to form the film of high quality in as-depo, there is no need of a conventional post-process (such as an annealing of heat treatment), or it is possible to shorten the time to conduct the post-process, thereby reducing manpower and contributing to a cost merit for equipment and an energy merit for environment.

### Second Embodiment

A second embodiment of the film forming system in accordance with this invention will be explained with reference to drawings.

With the film forming system 1 in accordance with the second embodiment, a method for controlling the injection valve 4 is different from the method of the first embodiment.

More specifically, with the film forming system 1 in accordance with the second embodiment, the control unit 11 controls the injection valve 4 so as to periodically, more specifically, alternately repeat the supplying period as being a period while the liquid precursor is directly injected, vaporized and supplied into the chamber 3 and the supply halt period as being a period while the liquid precursor is not supplied in the chamber 3, and further opens and closes the injection valve 4 multiple times at a predetermined intervals during the supplying period so as to supply the liquid precursor into the chamber 3.

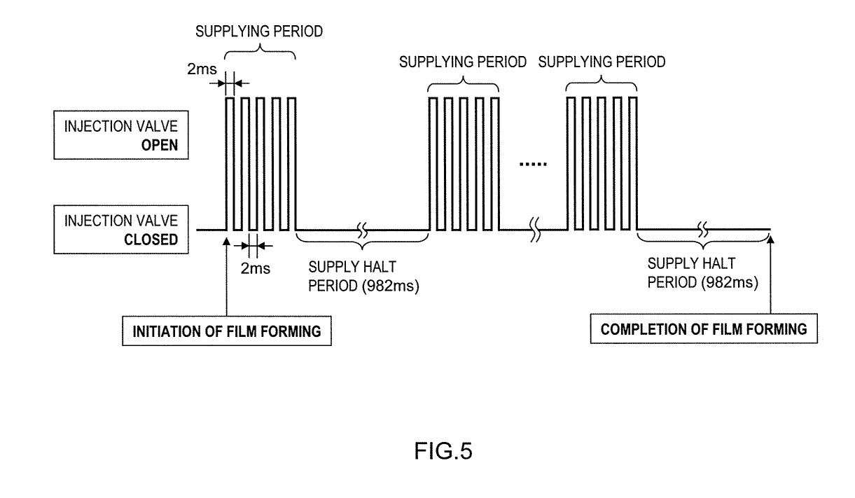

With a concrete method for controlling the injection valve 4, as shown in FIG. 5, the supplying period is set to 18 [ms] and the supply halt period is set to 982 [ms]. Then the liquid precursor is supplied into the chamber 3 five times at every 2 [ms] with intervals of 2 [ms] during the supplying period.

In accordance with this arrangement, since migration of the atoms or the molecules in the deposited thin film and vaporization of the reaction by-product material can be fully conducted, it is possible to produce a thin film of high grade having less impure substances and migration of the atoms or the molecules in the deposited thin film can be fully conducted, thereby to further promote vaporization of the reaction by-product material. Furthermore, the liquid precursor can be effectively made use of and in addition, since there is no need of using multiple injection valves 4, it goes without saying that a cost of the system can be reduced.

### Third Embodiment

Next, a third embodiment of the film forming system in accordance with this invention will be explained with reference to drawings.

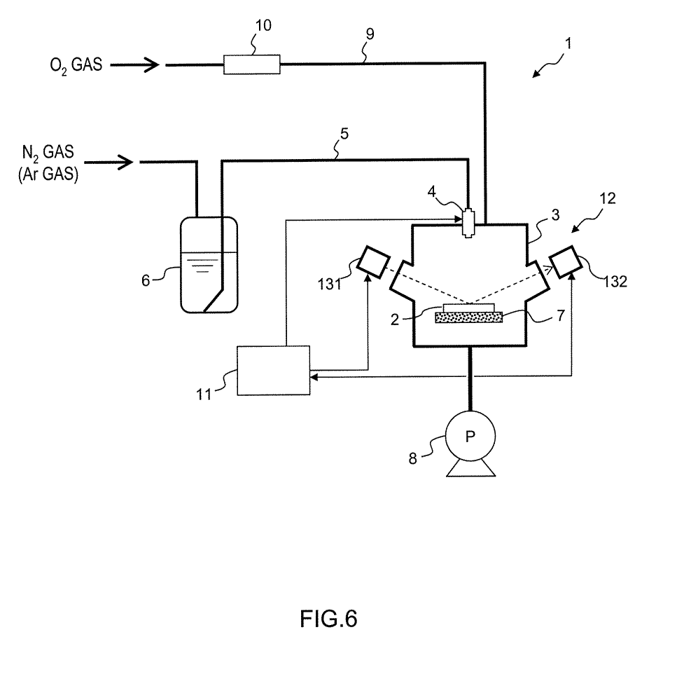

The film forming system 1 in accordance with this embodiment is a film forming system to form a film of tantalum pentoxide (Ta₂O₅) on a substrate 2 as being an object to be processed, as shown in FIG. 6, and a concrete main arrangement comprises a chamber 3 inside of which the substrate 2 is held, an injection valve 4 that directly injects the liquid precursor into the chamber 3, a material supplying pipe 5 that supplies the injection valve 4 with the liquid precursor, a control unit 11 and an ellipsometer 12.

The liquid precursor in this embodiment uses a mixed solution composed of pentaethoxytantalum (Ta(OC₂H₅)₅) as being an organic tantalum compound and n-pentane (n-C₅H₁₂) with a mixing ratio of {(Ta(OC₂H₅)₅)/(Ta(OC₂H₅)₅)+n-C₅H₁₂}=0.2 (mol ratio). The mixed solution composed of pentaethoxytantalum (Ta(OC₂H₅)₅) and n-pentane (n-C₅H₁₂) is stored in a container 6, passes through the precursor supplying pipe 5 due to pressurized N₂ gas (Ar gas) pressed into the container 6, is supplied to the inside of the chamber 3 through the injection valve 4 and then is vaporized and filled in the chamber 3.

An oxygen supplying pipe 9 is arranged in the chamber 3 to supply oxygen (O₂) gas for fully oxidizing the tantalum pentoxide (Ta₂O₅) film.

Furthermore, the pressure in the chamber 3 is adjusted by a vacuum pump 8 so that pentaethoxytantalum (Ta(OC₂H₅)₅) in the mixed solution injected into the chamber 3 vaporizes. More specifically, the pressure in the chamber 3 is made to be both larger than a vapor pressure of pentaethoxytantalum (Ta(OC₂H₅)₅) prior to being mixed with n-pentane (n-C₅H₁₂) and smaller than a vapor pressure of the mixed solution composed of n-pentane (n-C₅H₁₂) and pentaethoxytantalum (Ta(OC₂H₅)₅). In this embodiment, n-pentane (n-C₅H₁₂) is used as the low boiling point organic compound, however, other material, for example, alcohol such as ethanol (C₂H₅OH) may be used.

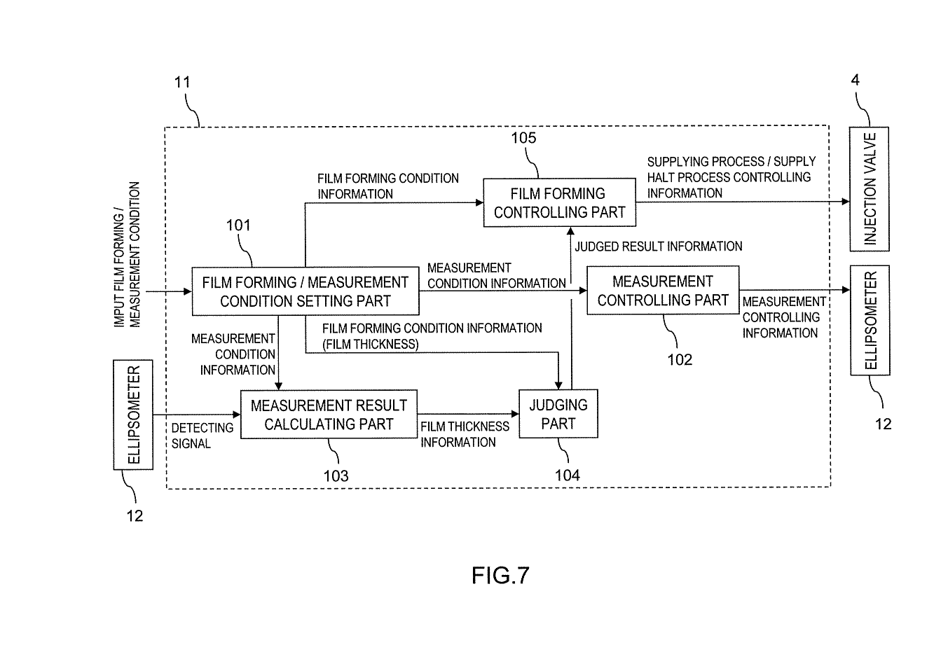

The control unit 11 is, so called, an information processing unit having a CPU, an internal memory, an external memory unit such as an HDD, and an input means such as a mouse and a key board. The control unit 11 functions as a film forming/measurement condition setting part 101, a measurement controlling part 102, a measurement result calculating part 103, a judging part 104 and a film forming controlling part 105, as shown in FIG. 7, with the CPU and its peripheral devices acting based on a program stored in a predetermined area of the internal memory or the external memory unit. The control unit 11 may be a general-purpose computer or a dedicated computer.

The film forming/measurement condition setting part 101 receives film forming condition information and measurement condition information input by the input means, or input by the input means and stored in the external memory unit and then stores the film forming condition information and the measurement condition information.

The measurement controlling part 102 receives the measurement condition information by accessing the film forming/measurement condition setting part 101 and outputs measurement controlling information for controlling a light source 131 and a detecting part 132 of the ellipsometer 12 based on the measurement condition information.

The measurement result calculating part 103 receives the measurement condition information by accessing the film forming/measurement condition setting part 101, receives a detecting signal from the detecting part 13 of the ellipsometer 12, calculates a measurement result of a film deposited on the substrate 2 based on the measurement condition information and the detecting signal, and outputs film thickness information among the measurement result.

The judging part 104 receives the film forming condition information including the film thickness by accessing the film forming/measurement condition setting part 101, receives the measurement result (the film thickness information) output by the measurement result calculating part 103, judges whether or not the film in course of forming satisfies a predetermined film forming condition by making a comparison between the film forming condition information and the measurement result, and outputs judged result information.

The film forming controlling part 105 receives the film forming condition information including the film thickness by accessing the film forming/measurement condition setting part 101, receives the judged result information output by the judging part 104 and outputs supply process controlling information and/or supply halt process controlling information so as to control each part of the film forming system 1 including the injection valve 4 based on the judged result information.

The injection valve 4 is controlled according to the supply process controlling information and/or the supply halt process controlling information output by the film forming controlling part 105, and supplies the liquid precursor into the chamber 3 intermittently by opening and closing periodically. The injection valve 4 is controlled to inject a predetermined amount of the liquid precursor by driving a solenoid 42 during a supplying period, to be described later, with monitoring the pressure of the liquid precursor in the precursor supplying pipe 5 by the use of a pressure gauge 14 and by opening the injection tip 41A.

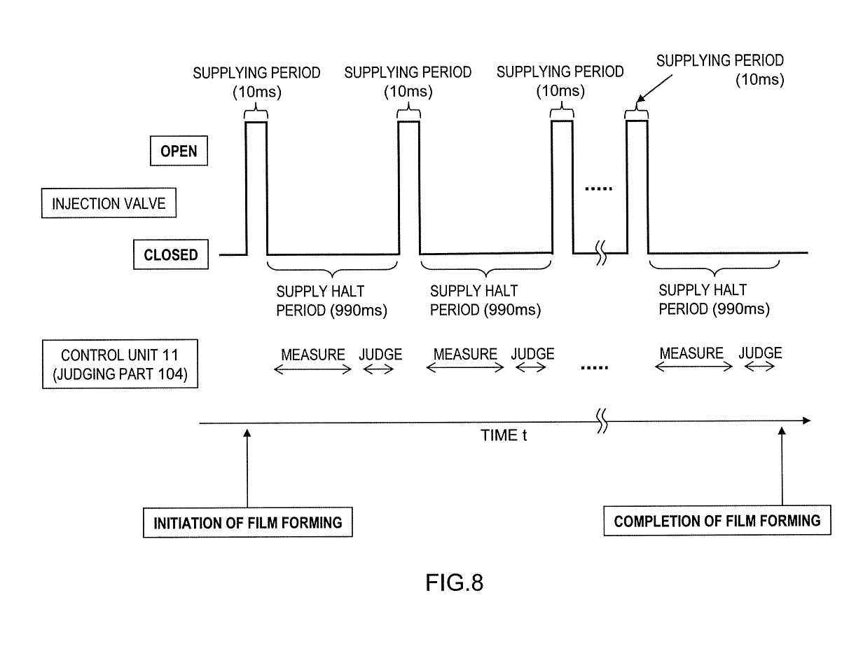

A concrete controlling method is, as shown in FIG. 8, to control the injection valve 4 so that the supplying process and the supply halt process are repeated alternately, and in this embodiment, the supplying period is 10 [ms] and the supply halt period is 990 [ms].

The ellipsometer 12 measures a thickness of the film deposited on the substrate 2 held in the chamber 3, and comprises a light source 131 and a detecting part 132. The light source 131 and the detecting part 132 of the ellipsometer 12 are arranged on a side surface of the chamber 3, and so arranged that light projected from the light source 131 during the supply halt period reflects on the film and the reflected light is detected by the detecting part 132.

The control unit 11 (the judging part 104), as shown in FIG. 8, receives the detecting signal during the supply halt period, measures the film thickness of the film deposited on the substrate 2 and judges whether the film thickness reaches a predetermined value or not.

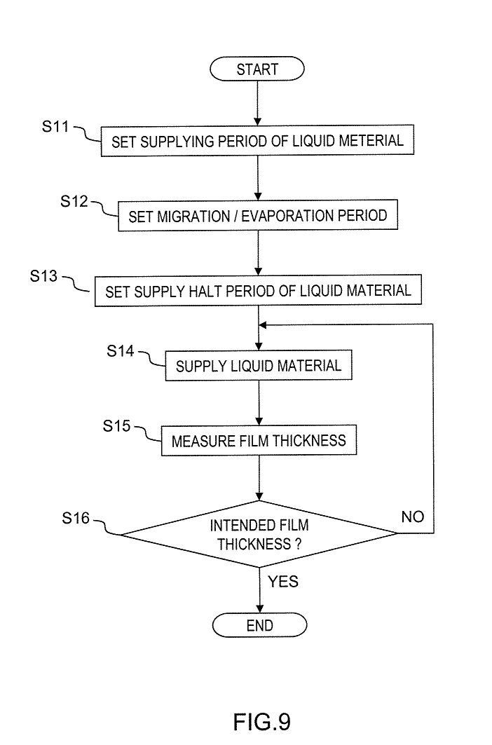

An operation of the film forming system 1 of the above-mentioned arrangement will be explained with reference to FIG. 9.

Step S11 ˜step S13 are the same as the above-mentioned step S1˜step S3.

Next, input an intended film thickness or an optical constant such as a refraction index in addition to the supplying period and the supply halt period into the control unit 11. The input intended film thickness or the optical constant, the supplying period and the supply halt period are stored in the film forming/measurement condition setting part 101 as the film forming condition information or the measurement condition information. The film forming controlling part 105 controls the solenoid 42 based on the film forming condition information and supplies the liquid into the chamber 3 (step S14).

When supply of the liquid precursor is halted, the light is projected from the ellipsometer 12 controlled by the measurement controlling part 102 based on the measurement condition information that has been previously input and the detecting signal of the deposited film is obtained (step S15). The thickness of the film and/or the optical constant such as the refraction index is calculated by the measurement result calculating part 103 based on the detecting signal detected by the detecting part 13 and a parameter for calculation included in the measurement condition information. The calculated thickness of the film and/or the optical constant is output to the judging part 104 and the judging part 104 judges whether the thickness of the film reaches an intended (desired) film thickness or not. If the calculated thickness of the film reaches the intended film thickness, the film forming controlling part 105 outputs a halt signal and terminates an operation of the film forming system 1. If the calculated thickness of the film does not reach the intended film thickness, film forming is continued (step S16).

In this embodiment, for example, the temperature of the substrate 2 is set at 400 degrees centigrade˜500 degrees centigrade, the pressure in the chamber 3 is set to about 0.1 Torr and a flow rate of the oxygen (O₂) gas is kept 500 ml/min.

In accordance with the film forming system 1 having the above arrangement, since migration of the atoms or the molecules in the deposited thin film or vaporization of the reaction by-product material can be fully conducted, it is possible to produce a thin film of high grade having less impure substances.

### Forth Embodiment

Next, a forth embodiment of the present claimed invention will be explained with reference to drawings.

With a film forming system 1 in accordance with this embodiment, a method for controlling the injection valve 4 is different from the method of the third embodiment.

More specifically, with the film forming system 1 in accordance with this embodiment, the liquid precursor is supplied into the chamber 3 by opening and closing the injection valve 4 multiple times at predetermined intervals in the above-mentioned supplying process.

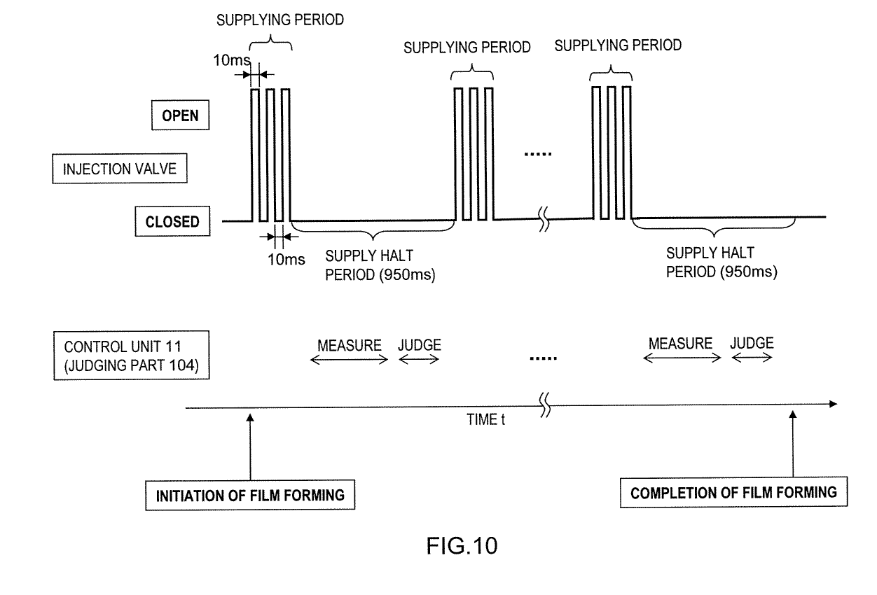

With a concrete method for controlling the injection valve 4, as shown in FIG. 10, a supplying period is set to 50 [ms] and a supply halt period is set to 950 [ms]. And the liquid precursor is supplied into the chamber 3 for 10 [ms] three times with intervals of 10 [ms] during the supplying period.

In accordance with this arrangement, since an amount of supplying the liquid precursor in one cycle can be made three times of the amount in the third embodiment, the time required for film forming can be shortened. In addition, since migration of the atoms or the molecules in the deposited thin film or vaporization of the reaction by-product material can be further promoted, it is possible to produce a thin film of high grade having less impure substances.

The present claimed invention is not limited to the above-mentioned embodiment.

For example, in the first embodiment, the supplying period is set to 10 [ms] and the supply halt period is set to 990 [ms], however, it is acceptable on the condition that the supply halt period is equal to or longer than the migration/evaporation period.

In addition, in the second embodiment, the injection valve 4 is controlled to open and close at intervals of 2 [ms] during the supplying period, however, it is not limited to this and the injection valve 4 may be controlled to open and close at intervals of 3 [ms]. In addition, in the second embodiment, the supplying period is set to 18 [ms] and the supply halt period is set to 982 [ms], however, it is acceptable on the condition that the supply halt period is set to be equal to or longer than the migration/evaporation period.

Furthermore, the supplying period of the liquid precursor in a first cycle may be set to 50 [ms] like the forth embodiment during a primary stage of film forming and the supplying period of the liquid precursor may be reduced to 10 [ms] like the third embodiment when the film thickness comes close to an intended film thickness. As mentioned, if the amount of supplying the liquid precursor is increased in a primary stage of film forming and the amount of supplying the liquid precursor is decreased in a later stage of film forming, it is possible to shorten the time required for film forming and to maintain a high accuracy of controlling the film thickness.

In the third and forth embodiments, the method for forming a metal oxide film is explained, however, the present claimed invention can also be applied to a method for forming a metal nitride film or a film of metal-nitride-oxide. In case of forming this film, the oxygen (O₂) gas supplied to the chamber 3 may be changed to an ammonia gas or a combination of the oxygen (O₂) gas and the ammonia gas.

The embodiment wherein film forming is conducted while the film thickness is measured like the third embodiment and the forth embodiment is appropriate for manufacturing a film of high quality. As the liquid precursor constituting the film of high quality represented are, for example, metal such as hafnium, aluminum, titanium, tantalum, barium, strontium, bismuth, lead, zirconium, lithium and silicon, and oxide or nitride of the above-mentioned metal, and these material may be appropriately combined to be a composite film.

In addition, while the liquid precursor is intermittently supplied, the supply halt period may be made gradually longer in conformity to the increase of a number of the atoms or the molecules that deposit on the substrate so as to secure the time for the atoms or the molecules on the substrate to fully migrate and for the reaction by-product material to fully evaporate.

In addition, a part or all of each embodiment or the modified form of the embodiment may be combined, and the present claimed invention may be variously modified without departing from the spirit of the invention.

### POSSIBLE APPLICATIONS IN INDUSTRY

As mentioned, in accordance with the present claimed invention, since migration of the atoms or the molecules in the deposited thin film or vaporization of the reaction by-product material can be fully conducted, it is possible to produce a thin film of high grade having less impure substances, and furthermore the liquid precursor can be effectively utilized. In addition, a film thickness can be precisely controlled.

1. A film forming method for forming a film by directly injecting a liquid precursor through an injecting valve into a chamber inside of which a substrate is held, vaporizing the liquid precursor and then depositing the vaporized liquid precursor on the substrate, comprising
a period setting step to set a migration/evaporation period necessary for atoms or molecules of the liquid precursor on the substrate to migrate and necessary for a reaction by-product material generated on the substrate to evaporate, and
an intermittent supplying step that is alternately provided with a supplying period while the liquid precursor is supplied by directly injecting the liquid precursor into the chamber and vaporizing the liquid precursor and a supply halt period while the liquid precursor is not supplied into the chamber, wherein
the supply halt period is set to be equal to or longer than the migration/evaporation period in the intermittent supplying step.

2. The film forming method described in claim 1, wherein
the liquid precursor is supplied into the chamber by opening/closing the injection valve multiple times at predetermined intervals during the supplying period of the intermittent supplying step.

3. The film forming method described in claim 1, wherein
the supply halt period is longer than the supplying period while the liquid precursor is supplied into the chamber.

4. The film forming method described in claim 3, wherein
the supply halt period is longer than or equal to about fifty times of the supplying period.

5. The film forming method described in claim 1, wherein
the supplying period is determined based on an area of an object to be film-formed of the substrate.

6. A film forming method for forming a film by directly injecting a liquid precursor through an injection valve into a chamber inside of which a substrate is held, vaporizing the liquid precursor and then depositing the vaporized liquid precursor on the substrate, alternately having
a supplying process that supplies the liquid precursor by directly injecting the liquid precursor into the chamber and vaporizing the liquid precursor and
a supply halt process that does not supply the liquid precursor into the chamber, wherein
in the supply halt process, the film deposited on the substrate is optically measured and the supplying process and/or the supply halt process is controlled based on the measurement result.

7. The film forming method for forming a film described in claim 6, wherein the film is optically measured with an ellipsometry method.

8. The film forming method described in claim 6, and manufacturing the film whose thickness is equal to or less than 2 nm.

9. A film forming system that forms a film by vaporizing a liquid precursor and then depositing the vaporized liquid precursor on a substrate, comprising
a chamber inside of which the substrate is held,
an injection valve that directly injects the liquid precursor into the chamber, and
a control unit that alternately sets a supplying period while the liquid precursor is directly injected into the chamber to supply the liquid precursor in a vaporized state and a supply halt period while the liquid precursor is not supplied into the chamber and controls the supplying period and the supply halt period by periodically opening and closing the injection valve so as to intermittently supply the liquid precursor into the chamber, wherein
the control unit controls the supply halt period to be equal to or longer than a migration/evaporation period necessary for atoms or molecules of the liquid precursor deposited on the substrate to migrate and necessary for a reaction by-product material generated on the substrate to evaporate.

10. The film forming system described in claim 9, wherein
the control unit opens and closes the injection valve multiple times at predetermined intervals during the supplying period so as to supply the liquid precursor into the chamber.

11. The film forming system described in claim 9, wherein
the injection valve comprises an electromagnetic coil and a valve plug that opens and closes an injection tip by means of electromagnetic induction of the electromagnetic coil.

12. The film forming system described in claim 9, wherein
the liquid precursor is a mixed solution composed of a metal compound and a low boiling point organic compound.

13. A film forming system that forms a film by vaporizing a liquid precursor and depositing the vaporized liquid precursor on a substrate, comprising
a chamber inside of which the substrate is held,
an injection valve that directly injects the liquid precursor into the chamber,
a measuring device that optically measures the film deposited on the substrate, and
a control unit that alternately sets a supplying process while the liquid precursor is directly injected into the chamber to supply the liquid precursor in a vaporized state and a supply halt process while the liquid precursor is not supplied into the chamber and controls the supplying process and the supply halt process by periodically opening and closing the injection valve so as to intermittently supply the liquid precursor into the chamber and that controls the measuring device to conduct the measurement during the supply halt process and controls the supplying process and/or the supply halt process based on the measurement result.

14. The film forming system described in claim 13, wherein
the measuring device is an ellipsometer.

15. The film forming system described in claim 13, wherein
the control unit comprises
a film forming/measurement condition setting part that stores film forming condition information and measurement condition information,
a measurement controlling part that outputs measurement controlling information for controlling each part of the measuring device based on the measurement condition information,
a measurement result calculating part that calculates and outputs a measurement result of the film deposited on the substrate based on the measurement condition information and a detecting signal output by the measuring device,
a judging part that judges whether or not the deposited film satisfies a predetermined film forming condition by making a comparison between the film forming condition information and the measurement result of the deposited film and that outputs judged result information, and
a film forming controlling part that outputs supply process controlling information and/or supply halt process controlling information based on the film forming condition information and/or the judged result information output by the judging part so as to control each part of the film forming system.

16. The film forming method described in claim 2, wherein
the supply halt period is longer than the supplying period while the liquid precursor is supplied into the chamber.

17. The film forming method described in claim 7, and manufacturing the film whose thickness is equal to or less than 2 nm.

18. The film forming system described in claim 10, wherein
the injection valve comprises an electromagnetic coil and a valve plug that opens and closes an injection tip by means of electromagnetic induction of the electromagnetic coil.

19. The film forming system described in claim 10, wherein
the liquid precursor is a mixed solution composed of a metal compound and a low boiling point organic compound.

20. The film forming system described in claim 14, wherein
the control unit comprises
a film forming/measurement condition setting part that stores film forming condition information and measurement condition information,
a measurement controlling part that outputs measurement controlling information for controlling each part of the measuring device based on the measurement condition information,
a measurement result calculating part that calculates and outputs a measurement result of the film deposited on the substrate based on the measurement condition information and a detecting signal output by the measuring device,
a judging part that judges whether or not the deposited film satisfies a predetermined film forming condition by making a comparison between the film forming condition information and the measurement result of the deposited film and that outputs judged result information, and
a film forming controlling part that outputs supply process controlling information and/or supply halt process controlling information based on the film forming condition information and/or the judged result information output by the judging part so as to control each part of the film forming system.
